(19) United States
(12) Patent Application Publication
(10) Pub. No.: US 2019/0257414 A1
(43) Pub. Date: Aug. 22, 2019

(54) AUTOMATIC TRANSMISSION CONTROLLER

(71) Applicant: DENSO CORPORATION, Kariya-city (JP)

(72) Inventor: Yasuaki IBAYASHI, Kariya-city (JP)

(21) Appl. No.: 16/257,258

(22) Filed: Jan. 25, 2019

(30) Foreign Application Priority Data
Feb. 16, 2018 (JP) 2018-26056

(51) Int. Cl. F16H 61/02

(52) U.S. Cl. CPC F16H 61/0204; F16H 2061/0255; F16H 61/0251

(57) ABSTRACT

A current controller in an automatic transmission controller shifts to a gear position from among a plurality of gear positions of a transmission mechanism by performing a current control for supplying an electric current to at least one of a plurality of solenoids corresponding to the plurality of gear positions. When the gear position is currently shifted or is going to be shifted from a pre-change gear position to a post-change gear position, the current controller distinguishes a target solenoid to operate from a non-target solenoid for shifting to the post-change gear position. The current controller performs the current control for the non-target solenoid using a control method having a lighter processing load than the processing load of the current control method for the target solenoid.

### CROSS REFERENCE TO RELATED APPLICATION

The present application is based on and claims the benefit of priority of Japanese Patent Application No. 2018-026056, filed on Feb. 16, 2018, the disclosure of which is incorporated herein by reference.

### TECHNICAL FIELD

The present disclosure relates to an automatic transmission controller.

### BACKGROUND ART

An automatic transmission controller controls an automatic transmission by controlling an electric current supplied to a linear solenoid valve (referred to simply as a “solenoid”) for hydraulic control in order to improve the feel of the vehicle while driving (i.e., drive feeling).

Given an increase in the number of gears in automatic transmissions, more solenoids may have to he added to switch to different gear positions. The control of an increased number of solenoids may cause an increased processing load on the automatic transmission controller. As such, automatic transmission controllers are subject to improvement.

### SUMMARY

The present disclosure describes an automatic transmission controller that is capable of reducing a processing load without compromising the responsiveness of a current control.

In an aspect of the present disclosure, a current controller performs a feedback control of an electric current (i.e., current feedback control) to a plurality of solenoids respectively corresponding to multiple gears (i.e., gear positions), for shifting a transmission mechanism to one of the multiple gears e., to one of multiple gear positions).

### BRIEF DESCRIPTION OF DRAWINGS

FIG. 1 illustrates functional blocks of a part of a vehicle control system according to a first embodiment of the present disclosure;

FIG. 2 illustrates an electrical configuration for operating an automatic transmission

FIG. 3 is a table illustrating the corresponding relationship between a shift state and a clutch state:

FIG. 4 is a flowchart of part of a control process;

FIG. 5 is a flowchart of another part of the control process shown in FIG. 4;

FIG. 6 illustrates a relationship between shiftable gear positions and a vehicle speed in an M mode;

FIG. 7 illustrates a D-range shift line and a relationship between the vehicle speed and the shiftable gear positions;

FIG. 8 is a table illustrating a relationship between (i) a role of an input shaft of a transmission mechanism as a driving body, a driven body, or an in-between body, and (ii) a shift pattern;

FIG. 9 is a flowchart of a current control process;

FIG. 10 is a timing chart of a gear shift operation example; and

FIG. 11 illustrates operation states of a current feedback control and a change in a processing load amount.

### DETAILED DESCRIPTION

Embodiments of the automatic transmission controller that is part of a vehicle control system are described below with reference to the accompanying drawings.

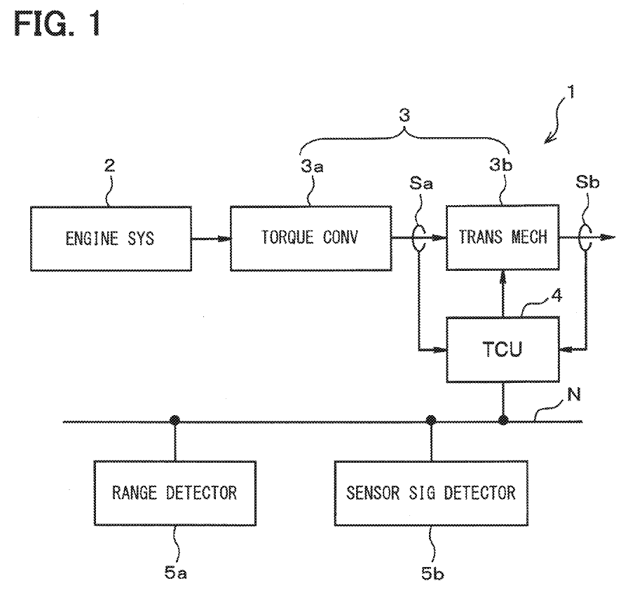

FIG. 1 illustrates part of a vehicle control system 1. As shown in FIG. 1, a vehicle control system 1 may include an engine system 2 and an automatic transmission 3 as components. The engine system 2 is a source of propulsion force for the vehicle (not shown) and the automatic transmission 3 is for transmitting a rotational drive torque of an output shaft of the engine system 2 to the vehicle's wheels (not shown). The automatic transmission 3 includes a torque converter 3a and a transmission mechanism 3h, and the automatic transmission 3 is connected to a Transmission Control Unit (TCU) 4. The TCU 4 may be connected to a range detector 5a and a sensor signal detector 5h via an in-vehicle network N. The range detector 5a is configured to function as a range detector. The TCU 4 is connected to an input rotation number sensor Sa for detecting a number of rotations of an input rotation shaft inputting torque from the torque converter 3a to the transmission mechanism 3b, and an output rotation number sensor 5b for detecting a number of rotations and a rotation torque of an output rotation shaft output from the automatic transmission 3. The number of rotations of the input rotation number sensor Sa. and output rotation number sensor Sb may be referred to collectively as “S,” and the number of rotations S may be input to the TCU 4.

The engine system 2 controls an electronic throttle valve in an electronically-controlled throttle system (not shown) based on an amount of accelerator pedal operation (e.g., by a driver). As such, the engine system 2 controls an intake air amount to the engine and controls a. rotational driving force of the engine output shaft. The engine system 2 is, for example, an internal-combustion engine such as a gasoline engine or a diesel engine. The rotational driving force of the output shaft of the engine system 2 is transmitted to an input shaft of the automatic transmission 3. The torque converter 3a transmits the rotational driving force of the output shaft of the engine system 2 to the input shaft of the transmission mechanism 3b via a hydraulic fluid (not shown).

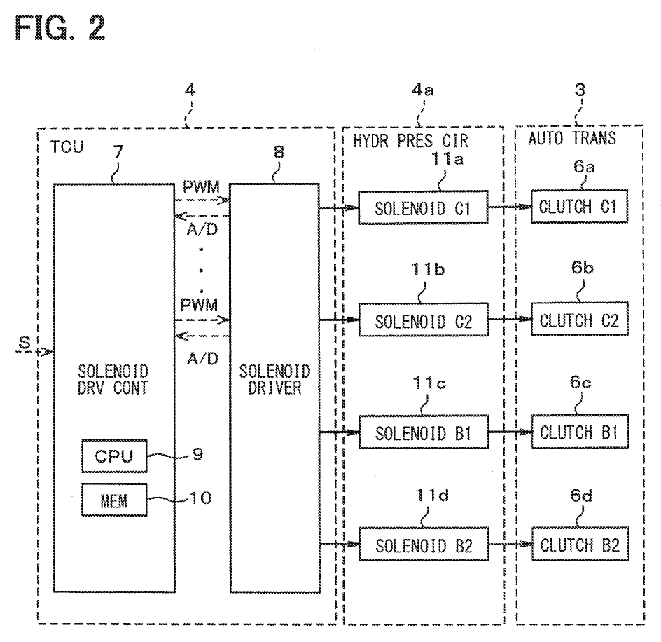

With reference to FIG. 2, the transmission mechanism 3b includes a plurality of gears using a planetary gear for switching a gear ratio between the input shaft and the output shaft (all not shown), and a plurality of clutches 6a to 6d connected to the respective gears. A hydraulic circuit 4a controls the engagement/disengagement (i.e., release) of the clutches 6a to 6d for switching the gear ratio of the input and output shafts.

With reference again to FIG. 1, the range detector 5a detects a range corresponding to a position of a shift lever, e.g., based on a shifting operation by the driver, and outputs the detected information to the network N as an operation state of the driver. The operation state of the driver may be referred to more simply as an “operation state.” In a vehicle having an automatic transmission with a manual mode (M mode), i.e., a manumatic transmission, the positions of the shift lever may include a P range indicating parking, an R range indicating reverse, an N range indicating neutral, a D range indicating drive, together with “+” for upshifting and “−” for downshifting in the M mode. The TCU 4 receives the detected range information as an input from the range detector 5a through the network N.

The sensor signal detector 5b detects various sensor signals such as an accelerator opening degree signal from an accelerator opening degree sensor and a. throttle opening degree signal from a throttle opening degree sensor as an in-vehicle state of the vehicle. The in-vehicle state of the vehicle may be referred to simply as the “in-vehicle state,” The accelerator opening degree signal and the throttle opening degree signal may change based on the opening degree of the accelerator, for example, as operated by the driver. The sensor signal detector 5b outputs the detected in-vehicle state to the network N. The “accelerator opening degree” may also be referred to more simply as the “accelerator opening.” In the description, the sensor signal detector 5b may be described singularly, but represent one or more electronic control units (ECUs) that either collectively or individually receive the various sensor signals. That is, the vehicle control system 1 may include a plurality of sensor signal detector 5b. even though the description describes a singular sensor signal detector 5b for ease of understanding. The TCU 4 can receive the in-vehicle state as an input by acquiring those sensor signals through the network N.

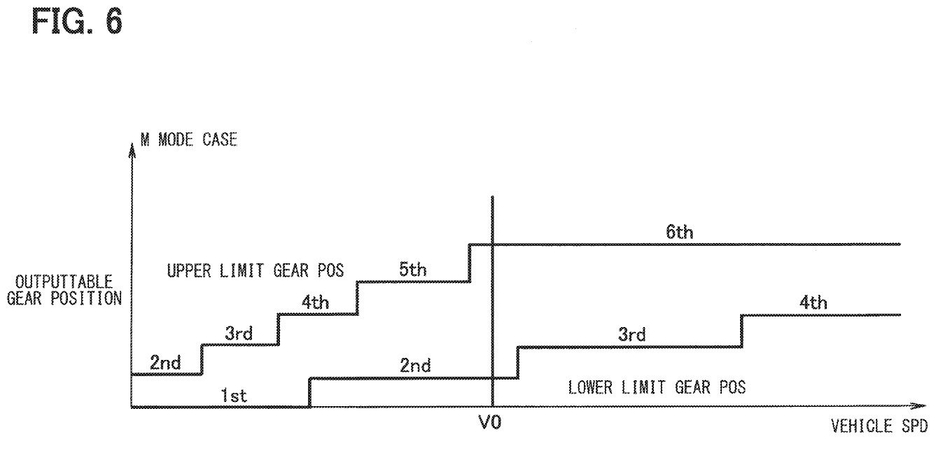

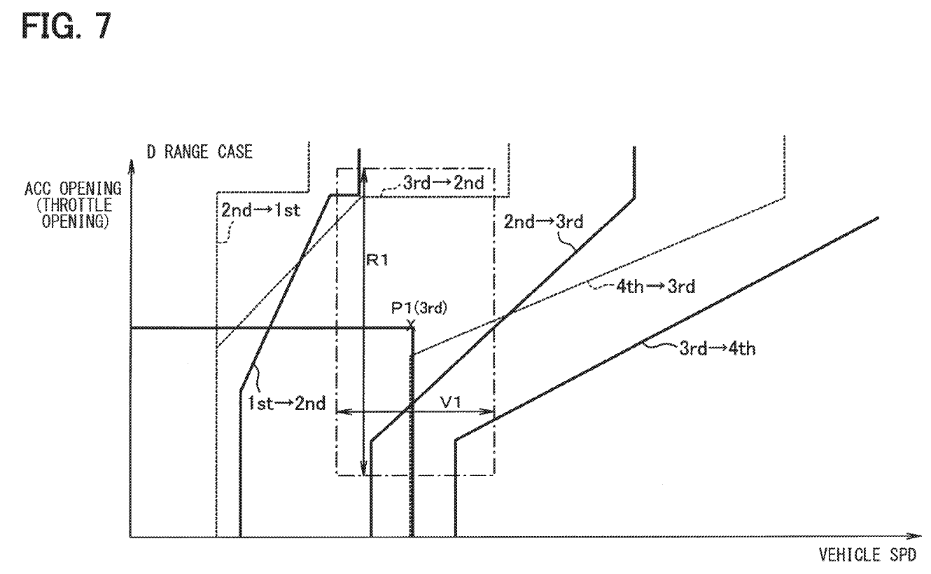

As shown in FIG. 2, the TCU 4 includes a solenoid drive controller 7 and a solenoid driver 8. The solenoid drive controller 7 may be referred to simply as the “controller” 7. The controller 7 includes one or more microcomputers including a. CPU 9 and a memory 10 such as a RAM, a ROM, and a flash memory. The memory 10 is used as a non-transitory, substantive storage medium, and stores an M-mode shift line and a D-range shift line. The M-mode shift line and the D-range shift line are described below in greater detail with reference to FIGS. 6 and 7. The memory 10 is used as an M mode shift line input section and a D range shift line input section. As such, the memory 10 may be referred to as the D range shift line input section 10 for inputting the D range shift line. The memory 10 may be referred to as the M mode shift line input section 10 for inputting the M mode shift line. The controller 7 realizes various functions by executing a program stored in the memory 10 by the CPU 9. For example, depending on the function performed by the controller 7, the controller 7 may function as a current controller, a distinguisher, and an input section. The functions of the controller 7 may be described in greater detail below relative to processes illustrated in the flowcharts. The controller 7 can calculate a current vehicle speed by using the sensor signals from the rotation number sensors Sa and Sb and/or the sensor signals) of the sensor signal detector 5b. The controller 7 can also calculate an acceleration from the time change of the vehicle speed (e.g., as a time derivative).

Based on the detection result of the range detected by the range detector 5a, in the M mode (i.e., in a manual shift mode), the TCU 4 sequentially increases upshifts) the gear position of the transmission mechanism 3b upon receiving an instruction of “+” (e.g., as an input from the shift lever) and sequentially decreases (i.e., downshifts) the gear position of the transmission mechanism 3b upon receiving an instruction of “−” (e.g., as an input from the shift lever). In the D range (i.e., the drive range in the automatic shift range), the TCU 4 uses the D-range shift line stored in the memory 10 to switch from the 1st range to 6th range either sequentially step-by-step (e.g, gear-by-gear from 1st gear to 2nd gear, 2nd gear to 3rd gear, etc.) or by jumping two more of more gears per shift operation (e.g., 1st gear to third gear).

As shown in FIG. 2, the controller 7 of the TCU 4 outputs a pulse width modulation (PWM) signal to the solenoid driver 8 for driving each of the clutches 6a to 6d. The controller 7 also hydraulically controls an operation of a plunger via linear solenoid valves (referred to simply as “solenoids”) 11a to 11d provided in the hydraulic circuit 4a, for controlling engagement/disengagement states of the respective clutches 6a to 6d. The engagement/disengagement states of the respective clutches 6a to 6b may also be understood as coupling/decoupling states. The solenoids 11a to 11d are spool type hydraulic control valves used for pressure control of the hydraulic fluid supplied to a hydraulic actuator of the automatic transmission 3.

### Relationship Between the Engagement/Disengagement State of the Clutches and the Gear Position of the Automatic Transmission

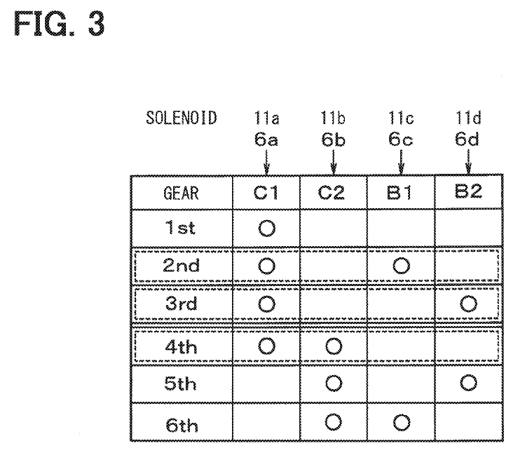

The relationship between the engagement/disengagement state of the clutches 6a to 6d and the gear position of the automatic transmission 3 is described with reference to FIG. 3. FIG. 3 shows a correspondence table of the engagement/disengagement state of the clutches 6a to 6d and the gear position of the automatic transmission 3 and the corresponding solenoids 11a to 11b used to control the clutches 6a to 6d. In FIGS. 3, 1st, 2nd, 3rd, 4th, 5th and 6th respectively indicate a forward gear position (e.g., from lowest gear to highest gear), and a “circle” in the box indicates an engagement state of each clutch, while no sign (i.e., the absence of a circle) indicates a disengaged state, that is, a release state of the clutch.

The TCU 4 realizes different combinations of engagement and release states of the clutches Ca to 6d corresponding to the requested gear position from among the multiple gear positions of the automatic transmission 3 when the requested gear position is detected by the range detector 5a.

For example, when the range detector 5a detects the D range and such information is transmitted to the TCU 4, the TCU 4 sequentially switches gear positions from 1st to 6th. In such case, when shifting to 3rd gear, the TCU 4 switches the engagement/release state of the clutches 6a to 6d corresponding to the forward 3rd position, and, in such 3rd range, the clutch 6a (C1) and 6d (92) are brought into the engagement state, and the clutches 6b (C2) and 6c (B1) are put in the release state.

For example, in 3rd gear (i.e., the 3rd range or 3rd position), the controller 7 is configured to use multiple types of electric current control methods for performing the current control for respectively controlling the solenoids 11a and 11d to engage the corresponding clutches 6a. (C1) and 6d (B2), and for controlling the solenoids 11b and tic to release the corresponding clutches 6b (C2) and 6c (B1). The multiple type current control methods may be, for example, a dither-chopper control method, a. current feedback control method, and a current feed forward control method. Other types of current control methods may also be used.

For the above-described current feedback control methods, a standard current value (i.e., a basic current value) of the applied direct current is set to a constant high value Ihi or to a constant low value Ilo. For example, Ihi may be the maximum value Imax of a direct current (DC) control range and Ilo may be the minimum value Imin of the DC control range. The controller 7 applies a PWM current to the solenoids 11a to 11d in an overlapping manner on/over the standard current value based on the PWM signal output from the controller 7. The current supplied to the solenoids 11a to 11d is detected by the A/D converter (not shown) and the amplitude of the PWM current is controlled to match the detected current to a target current value.

Among the current feedback control methods, the dither-chopper control method may be used in some cases. The dither-chopper control method is a method in which the controller 7 sets a fine-tuned control pulse cycle for a constant target current value together with a stepwise-changing target current value having a dither cycle (i.e., a cycle longer than the fine-tuned control pulse cycle) in order to match the PMW current to the target current value using the feedback control of the electric current. In the dither-chopper control method, the control pulse cycle of the target current value is shorter than the dither cycle, and the target current value can be dynamically changed for the control, in such manner, the dither-chopper control can provide a precise control with a high responsiveness. However, due to the dynamic change and control of the target current value, the processing load of the controller 7 and its CPU 9 substantially increases compared with the above-described simple current feedback control methods.

The current feed forward control method is a method in which the supply current to the solenoids 11a to 11d, is simply controlled to match its amplitude to the target current value, without detecting the supply current using the A/D converter, In the current feed forward control method, the feedback control based on the detected supply current supplied to the solenoids 11a to 11d is not performed, and the processing load is reduced compared with the current feedback control method described above.

The processing load is the heaviest for the dither-chopper control method followed by the current feedback control method without using the dither-chopper control method (e.g., intermediate processing load), while the processing load of the current feed forward control method is the lightest of these three methods. In the present embodiment, the controller 7 chooses among these current control methods for separately controlling each of the solenoids 11a to 11d to appropriately control the supply of the electric current to the solenoids 11a to 11d taking into account the processing load of the controller 7.

### Switching Method of Current Control Method

While it may be desirable to perform the current control for all the solenoids 11a to 11d by applying the dither-chopper control method due to the precision and responsiveness of the dither-chopper control, the increased responsiveness for such control also increases the processing load of the CPU 9 in the controller 7. Therefore, in order to reduce the processing load of the CPU 9, all the solenoids 11a to 11d are distinguished as either a target solenoid or a non-target solenoid. This distinction enables the controller 7 to perform certain current control methods based on whether the solenoid is a target solenoid or a non-target solenoid. In such manner, not all solenoids 11a to 11d are subject to the same current control method, and as such, the processing load of the controller 7 and CPU 9 can be further reduced. That is, a current control method for each of the solenoids 11a to 11d is selected by the controller 7 from among the multiple control methods, for a preferable outcome, and to reduce the processing load of the CPU 9.

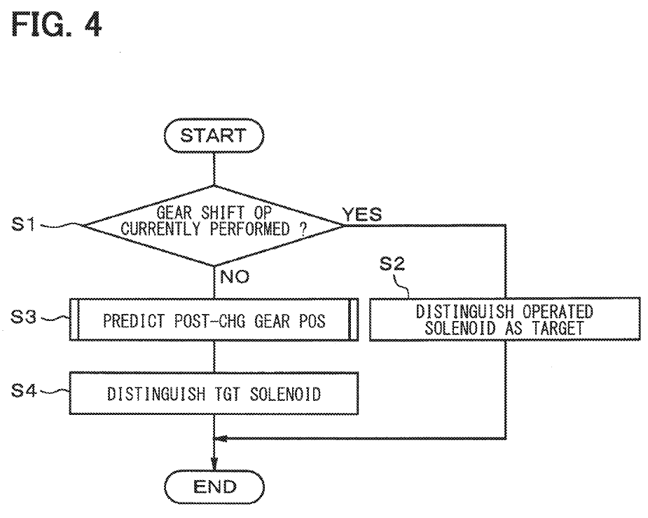

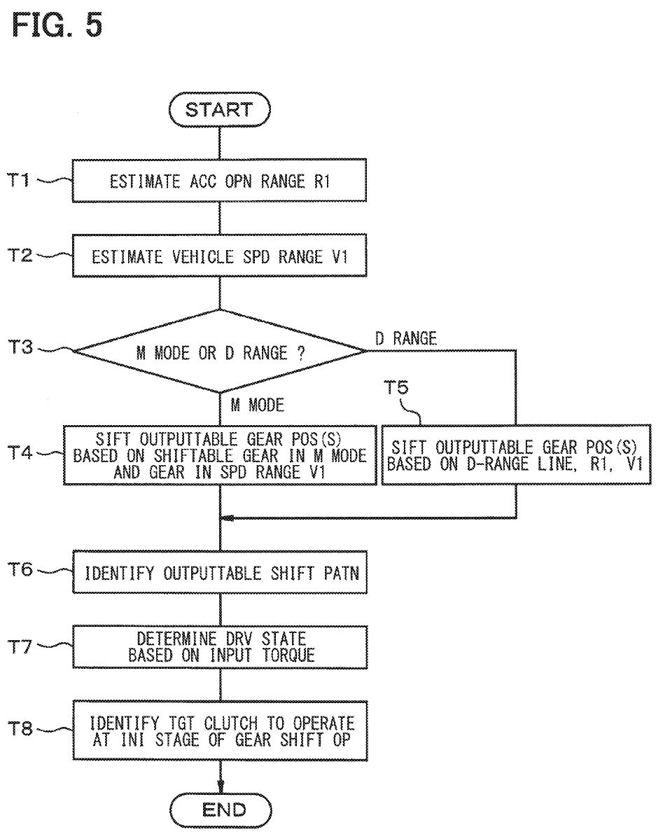

The details for the selection/switching process of the current control method are described with reference to FIGS. 4 and 5.

As shown in FIG. 4, at S1, the controller 7 determines whether a release/engagement operation of each of the solenoids 11a to 11d is performed to determine whether a gear shift operation is currently being performed. When the controller 7 determines that a gear shift operation is currently being performed, i.e., “YES” at S1, the process proceeds to S2, At S2, the controller 7 distinguishes the solenoid(s) that is/are currently operated in the gear shift operation as the target solenoid(s) from the non-operational solenoids as the non-target solenoids. That is, the controller 7 designates the solenoids operating during a gear shift operation as the target solenoid and designates the non-operational solenoids as the non-target solenoids. For example, with reference to FIG. 3, when the controller 7 is changing/shifting the gear position from a pre-change gear position 3rd to a post-change gear position 4th, the solenoids 11b and 11d are currently operated to respectively engage and disengage release) the corresponding clutches 6b and 6d. As such, the solenoids 11b and 11d are respectively distinguished as a target solenoid, and the non-operating solenoids 11a and 11c are respectively distinguished as a non-target solenoid.

With reference again to FIG. 4, at S1, when the controller 7 determines that a gear shift operation is not currently being performed, i.e. “NO” at S1, the process proceeds to S3. At S3, the controller 7 predicts the post-change gear position. That is, at S3, the controller 7 determines, based on the current gear position, possible or probable post-change gear positions (e.g., predicts gear positions after a shift operation from the current, pre-change gear position). The process then proceeds to S4 and the controller distinguishes the solenoid(s) that would operate to realize the predicted, post-change gear position(s) identified in S3 to be the target solenoids and the non-operational solenoids as the non-target solenoids.

When the controller 7 performs the processes at S2 and S4 the controller performs a distinguishing function to distinguish the target solenoids from the non-target solenoids. As such, the controller 7 may be referred to as a “distinguisher” when performing the processes at S2 and S4.

With reference to FIG. 5, the prediction process of the post-change gear position at S3 is described. At T1, the controller 7 estimates an accelerator opening range R1 that can be reached within a predetermined time based on the current accelerator opening degree detected by the sensor signal detector 5b. The following description is based on, i.e., uses, the accelerator opening range R1. However, as the accelerator opening increases, an electronic throttle opening also increases linearly in proportion to the accelerator opening. As such, the estimation of the opening range may be based either on the accelerator opening or the electronic throttle opening. The estimated opening range may be determined by assuming how far the accelerator opening will increase within a predetermined time from when the accelerator pedal is depressed by the driver at a current time. At T2, the controller 7 estimates a vehicle speed range V1 that can be reached within a predetermined time from the current time based on the current vehicle speed information and acceleration information detected by the sensor signal detector 5b.

At T3, the controller 7 determines whether the transmission mechanism 3b is currently in the D range or in the M mode, When the controller 7 determines that the transmission mechanism 3b is in the M mode, the process proceeds to T4 and the controller 7 determines a gear position or positions that can be output by sifting or narrowing all available gear positions of the transmission mechanism 3b based on (i) shiftable gear positions that can be shifted to by the gear shift operation from the current gear position, and (ii) gear positions that can be output based on the current vehicle speed range V1, For example, with reference to FIG. 6, when the current vehicle speed is V0, the controller 7 determines from the M-mode shift line that is stored in the memory 10 that the outputtable gear positions are gear positions between the 2nd and 6th gears. That is, the outputtable gear positions include both the 2nd and 6th gear and all the gears in between the 2nd and 6th gears. The M-mode shift line shows the relationship of the outputtable gear positions (that is, an upper limit gear position and a lower limit gear position) relative to the vehicle speed.

Alternatively, returning to T3, when the controller 7 determines that the transmission mechanism 3b is in the D range according to the range detector 5a, the process proceeds to T5. At T5, the controller 7 sifts (i.e., narrows) the outputtable gear position to one or more positions based on the D-range shift line shown in FIG. 7, the accelerator opening range R1, and the vehicle speed range V1.

When the controller 7 performs the processes at T1, T2, T3, T4, and T5, the controller performs an input function to input the operation state (of the driver) and the in-vehicle state (of the vehicle). As such, the controller 7 may be referred to as an “input section” when performing the processes at T1, T2, T3, T4, and T5.

When the controller 7 performs the process at T3, the controller performs a range information acquisition function that acquires range information from the range detector 5a to determine the current shift range of the shift lever e.g., D range, M mode). As such, the controller may be referred to as a “range information acquirer” when performing the process at T3.

As shown in FIG. 7, the D-range shift line is stored in the memory 10. Relationships between the vehicle speed and the accelerator opening (or the electronic throttle opening) for upshifting (e.g., 1st gear to 2nd gear, 2nd gear to 3rd gear, and 3rd gear to 4th gear) and for downshifting (e.g., 2nd gear to 1st gear, 3rd gear to 2nd gear, and 4th gear to 3rd gear) may be stored to the memory 10 in advance.

With reference to FIG. 7, when the controller 7 detects the relationship between the current vehicle speed and the current accelerator opening, for example, at point P1 for 3rd gear, the controller 7 defines the vehicle speed range V1 along a horizontal axis and the accelerator opening range R1 along a vertical axis. Both the vehicle speed range V1 and the accelerator opening range R1 are used to determine a rectangular area, shown by a one-dash-one-dot line centered about the point P1, where the rectangular area shown in FIG. 7 overlaps portions of the D-range shift lines. By defining such a rectangular area, it is possible to predict a gear position that can be output in the future. At TC, the controller 7 identifies a shift pattern that can actually be output based on the gear position or positions identified by the sifting process as possible output gear(s) in T5.

For example, assuming that the current gear position is 3rd gear and that the rectangular area is defined by the vehicle speed range V1 and the accelerator opening range R1, as shown in FIG. 7, this area overlaps portions of the D-range shift lines where the transmission is downshifted from 3rd gear to 2nd gear (i.e., 3rd 2nd) and upshifted from 3rd gear to 4th gear (i.e., 3rd→4th). The controller 7 predicts that the outputtable gear positions are 2nd gear and 4th gear, and identifies the outputtable shift pattern as 3rd gear to 2nd gear (i.e., “3rd→2nd”) and 3rd gear to 4th gear (i.e., “3rd 4th”).

Returning again to FIG. 3, upon predicting that the outputtable gear positions are 2nd gear and 4th gear, the controller 7 identifies that the clutch 6c (B1) needs to be engaged (i.e., transition from released→engaged) and that the clutch 6d (B2) needs to be disengaged/released (i.e., transition from engaged→released) to perform the shift operation for the shift patter 3rd gear to 2nd gear (i.e., “3rd→2nd”).

The controller 7 also identifies, for the gear shift operation of the shift pattern 3rd→4th, that the clutch 6b (C2) needs to be engaged (i.e., transition from released engaged) and that the clutch 6d (B2) needs to be released (i.e., transition from engaged→released). As such, when an upshift/downshift operation is performed from the 3rd gear, the clutches 6b, 6c, 6d are identified as clutches that could be operated during the upshift/downshift operations. That is, the controller 7 identifies the clutches 6b, 6c, and 6d as operation-candidate clutches.

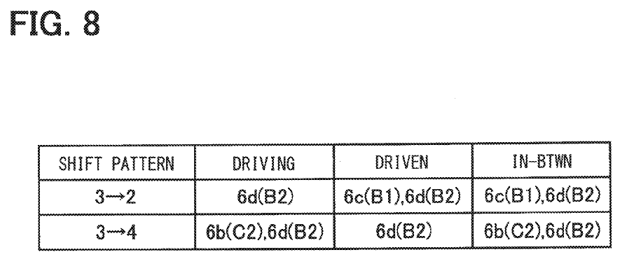

In such a case, at T7, the controller 7 may detect a current input of a turbine torque related to the input shaft of the transmission mechanism 3b, and, based on such a torque detection, the controller 7 may determine Whether the input shaft of the transmission mechanism 3b serves as a driving body, a driven body, or an in-between body (shown as “DRIVING,” “DRIVEN,” and “IN-BTWN” in FIG. 8). At T8, the controller 7 may identify a target clutch to operate at the beginning of the gear shift operation (shown as “AT INI(TIAL) STAGE OF GEAR SHIFT OP(ERATION)” in FIG. 5). The processes of T7 and T8 may be omitted. That is, without considering the input turbine torque of the input shaft of the transmission mechanism 3b, the processes from T1 to T6 in FIG. 5 may be used to distinguish a target solenoid at S4 in FIG. 4.

The processes at T7 and T8 are described with reference to FIG. 8. The correspondence table shown in FIG. 8 is stored in advance in a non-volatile memory 10. For example, the correspondence table in FIG. 8 may be stored to the non-volatile memory 10 during the manufacture of the controller 7 so that the correspondence table is preloaded and stored to the memory 10 of the controller 7 before the controller 7 leaves its place of manufacture.

“Driving” and “Driven” in FIG. 8 indicate a relation of whether the input shaft of the transmission mechanism 3b serves as a driving body or a driven body, in a slip-engagement situation of components between the engine system 2 and the transmission mechanism 3b. That is, “driving” and “driven” may refer to the engagement of components between the engine system 2 and the transmission mechanism 3b. Slip-engagement may refer to a smooth transitional engagement between the engine system 2 and the transmission mechanism 3b.

“Driving” may be a condition where the rotation number of the output shaft of the engine system 2 is increasing which in turn increases the turbine rotation number of the input shaft of the transmission mechanism 3b. In other words, “driving” may refer to conditions where the input torque of the transmission mechanism 3b is higher than a predetermined range. Such a condition is satisfied when, for example, the accelerator opening degree is greater than an upper limit value of the predetermined range. Such conditions may be referred to simply as “driving.”

“Driven” in FIG. 8 may be a condition where the rotation number of the output shaft of the engine system 2 is decreasing, which in turn causes the turbine rotation number of the input shaft of the transmission mechanism 3b to decrease. In other words, “driven” may refer to conditions where the input torque of the transmission mechanism 3b is lower than the predetermined range. Such a condition is satisfied when, for example, the accelerator opening degree is lower than the lower limit value of the predetermined range. Such conditions may be referred to simply as “driven.”

“In-between” describes an intermediate range where the input torque of the transmission mechanism 3b is within the predetermined range.

### “Driving”—Downshifting from 3rd Gear to 2nd Gear when the input Shaft of the Transmission Mechanism is a Driving Body

In the vehicle control system 1, When the automatic transmission 3 is downshifting from 3rd gear to 2nd gear (re., 3rd→2nd), the turbine rotation number of the input shaft of the transmission mechanism 3h increases. Based on such a rise of the turbine rotation number of the input shaft, the transmission mechanism 3b can be promptly driven by receiving an external assistance, and a control responsiveness of the hydraulic control by the controller 7 may be lowered voluntarily. As such, as shown in FIG. 8 for the “driving,” when the input torque of the transmission mechanism 3b is higher than the predetermined range, the controller 7 may select only the clutch 6d (B2) to transition from being engaged to being released (i.e., disengaged) for the downshift from 3rd gear to 2nd gear (i.e., 3rd→2nd) as a target clutch 6d (B2) to operate during a shift output prediction period.

Then, the controller 7 returns the process to S4 in FIG. 4, distinguishes only the solenoid 11d (B2) corresponding to the target clutch 6d as a target solenoid, and distinguishes the other solenoids 11a to 11c as the non-target solenoids.

### “Driven”—Downshifting from 3rd Gear to 2nd Gear when the input Shaft of the Transmission Mechanism is a Driven Body

Conversely, when the input torque of the transmission mechanism 3b is lower than the predetermined range, the transmission mechanism 3b is not driven by the engine system 2, resulting in an inferior control responsiveness. Therefore, both of the clutches 6c (B1) and 6d (B2) that respectively are engaged and released in the downshift operation from 3rd gear to 2nd gear are distinguished as a target clutch to operate during the shift output prediction period at the beginning of the gear shift operation. Then, the controller 7 returns to the process at S4 in FIG. 4, distinguishes the solenoids 11c (B1) and 11d (B2) corresponding to the target clutches 6c and 6d respectively as a target solenoid, and distinguishes the other solenoids 11a (C1) and 11b (C2) respectively as a non-target solenoid.

### “In-Between”—Downshifting from 3rd Gear to 2nd Gear for an In-Between Condition

The controller 7 sets the clutches 6c (B1) and 6d (B2) respectively as a target clutch for an in-between condition, that is, for an intermediate condition in between the “Driving” and “Driven” conditions. As such, the solenoids 11c (B1) and 11d (B2) are respectively distinguished as a target solenoid.

### “Driving”—Upshifting from 3rd Gear to 4th Gear when the input Shaft of the Transmission Mechanism is a Driving Body

When the automatic transmission 3 is upshifted, for example from 3rd gear to 4th gear, the turbine rotation number related to the input shaft of the transmission mechanism 3b decreases. As such, the assistance from the external engine system 2 disappears as the turbine rotation number decreases, and it may be preferable for the controller 7 to voluntarily raise the control responsiveness during the upshift. When the input torque of the automatic transmission 3 is higher than the predetermined range, the controller 7 selects both of the clutches a (C2) and 6d (B2) as a target clutch to operate (e.g., to engage/release) during the shift output prediction period at the beginning of the gear shift operation.

In such a case, the controller 7 returns to the process at S4 in FIG. 4, distinguishes the solenoids 11b (C2) and 11d (B2) corresponding to the target clutches 6b (C2) and 6d (B2) respectively as a target solenoid, and distinguishes the other solenoids 11a and 11c respectively as a non-target solenoid.

### “Driven”—Upshifting from 3rd Gear to 4th Gear when the Input Shaft of the Transmission Mechanism is a Driven Body

When the automatic transmission 3 is upshifted, for example, from 3rd gear to 4th gear, the turbine rotation number of the input shaft of the transmission mechanism 3b decreases. When the input torque of the transmission mechanism 3b is lower than the lower limit value of the predetermined range, the turbine rotation number naturally and inevitably decreases. As such, the controller 7 does not have to voluntarily raise the control responsiveness during the upshift process. Therefore, the clutch 6d (B2) released in the shift process is set as the target clutch to operate during the shift output prediction period at the beginning of the gear shift operation. In such a case, the controller 7 returns to the process at S4 in FIG. 4, distinguishes the solenoid 11d (B2) corresponding to the target clutch 6d as a target solenoid, and distinguishes the other solenoids 11a, 11b, and 11c respectively as a non-target solenoid.

### “In-Between”—Upshifting from 3rd Gear to 4th Gear for an In-between Condition

As shown in FIG. 8, the controller 7 distinguishes the clutches 6b (C2) and 6d (B2) respectively as a target clutch for the in-between condition.

### Current Control Process

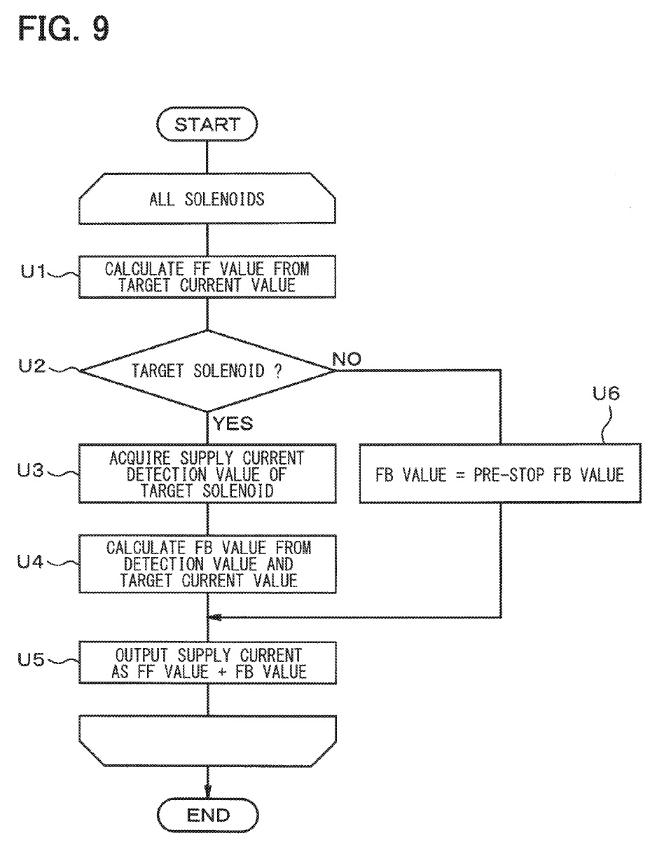

FIG. 9 is a flowchart showing a current control process that is performed after the controller 7 distinguishes between the target solenoid(s) and the non-target solenoid(s). That is, the process shown in the flowchart of FIG. 9 is performed after the controller designates which of the solenoids will operate as target solenoids and which of the solenoids will operate as non-target solenoids.

The process shown in FIG. 9 is a process separately performed for each of the solenoids 11a to 11d. That is, FIG. 9 shows a loop limit hexagon before the process at UI and a loop limit hexagon after U5. These loop limit symbols indicate the start and end of a loop performed in the flowchart of FIG. 9. “ALL SOLENOIDS” in the beginning loop symbol indicates that the processes between U1 and U5 are not performed by the controller 7 simultaneously for all of the solenoids 11a, 11b, 11c, and 11d, but rather one-by-one in a sequential order. For example, the controller 7 may run the process first for solenoid 11a, then solenoid 11b, and so on. A solenoid for which the controller 7 is currently performing the process flow in FIG. 9 may be referred to as the currently controlled solenoid.

A control value used for the current feed forward control may be referred to as an “FF value,” and a control value used for the current feedback control may be referred to as an “FB value.” At U1, the controller 7 first calculates the FF value from the target current value. At U2, the controller 7 then determines whether the currently controlled solenoid has been designated as a target solenoid. When the controlled 7 determines that the currently controlled solenoid has been designated (i.e., distinguished) as a target solenoid, i.e., “YES” at U2, the process proceeds to U3. At U3, the controller 7 acquires the supply current of the target solenoid using the A/D converter and the process proceeds to U4. At U4, the controller 7 calculates the FB value used for the current feedback control from the detected value of the supply current and the target current value. At U5, the controller 7 performs the current feedback control by adding the FF value and the FB value and outputting the sum as the supply current.

That is, when the controller 7 performs the current feedback control for a target solenoid, the processes at U2, U3, U4, and U5 are performed. However, if the controller 7 opts to use a more precise dither-chopper control method, a process that sets a target current value based on the dither cycle may be provided in between U2 and U3. In such manner, the current feedback control can be performed by using a more precise dither-chopper control method.

Returning to U2, when the controller 7 determines that the currently controlled solenoid is a non-target solenoid, i.e., “NO” at U2. the process proceeds to U6. At U6, the controller 7 may set the FB value to a pre-stop FB value before stopping the current feedback control (i.e., “PRE-STOP FB VALUE” in FIG. 9). At U5, the controller 7 may output the supply current having a value equal to the FF value+the FB value, where the FB value in this case is the pre-stop FB value that the controller sets at U6.

In the above-described control, although the FB value is used, the supply current currently supplied to the non-target solenoid is not acquired by using the A/D converter nor is the current feedback control based on the detected supply current value, thereby simplifying the current feed forward control. Consequently, the process of acquiring the supply current detection value at U3 may be omissible, and the calculation process of the FB value at U4 may also be omissible, where the omission of U3 and. U4 further lighten the processing load of the controller 7 and CPU 9. The process at U6 may also be omissible when the controller 7 makes a “NO” determination at U2. In this case, the controller 7 may set the FB value as a constant such as zero (“0”).

When the controller 7 performs the current controller processes in the flowchart of FIG. 9, the controller 7 performs a current control function to control the current feedback control and the current supply to the solenoids 11a to 11b. As such, the controller 7 may be referred to as a “current controller” when performing the processes in the flowchart of FIG. 9 (e.g., U1, U2, U3, U4, U5, and U6)

### Example

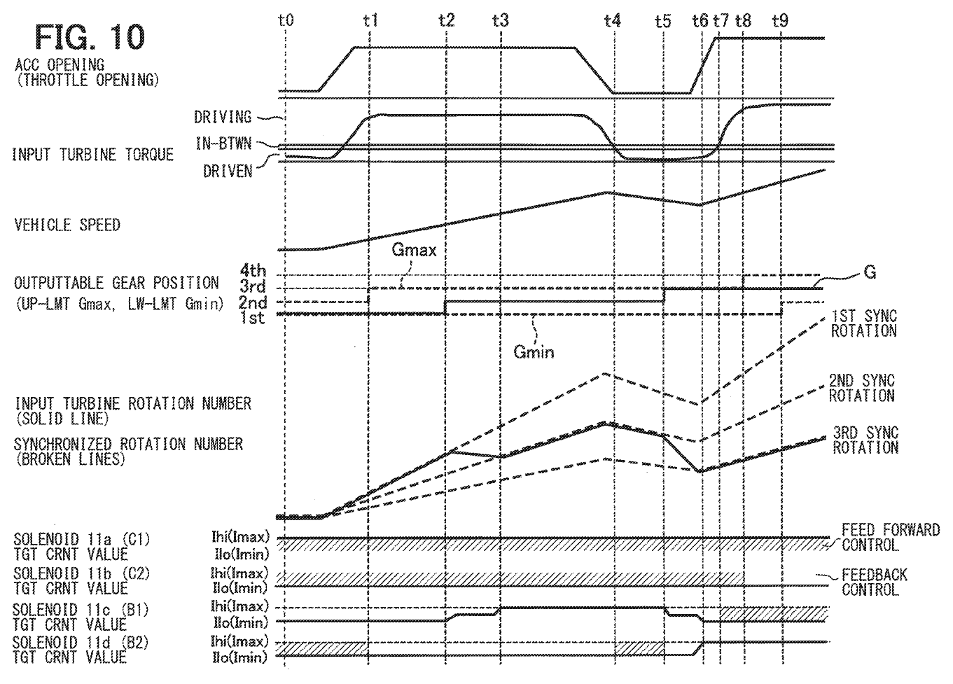

FIG. 10 illustrates a timing chart. The timing chart in FIG. 10 shows changes or transitions in the turbine rotation number and a synchronized rotation number, as well as changes in the current control of the target current of each of the solenoids 11a to 11d when the gears are sequentially shifted, e.g., 1st, 2nd, 3rd, immediately after starting a drive operation when the shift lever is shifted to the D range position.

When the driver depresses the accelerator pedal, the accelerator opening degree increases, for example, as shown in FIG. 10 before time t1. As such, if the gear position is in the D range, the input turbine torque of the transmission mechanism 3b also increases with some delay relative to the increase of the accelerator opening degree, for example, also shown in FIG. 10 before time U. When the driver releases the accelerator pedal, the accelerator opening degree decreases, as shown in FIG. 10 between times t3 and t4. As such, the input turbine torque of the transmission mechanism 3h also decreases with some delay from the decreasing change of the accelerator opening degree also shown in FIG. 10 between times t3 and t4. In 1st (gear), shown as the period up to time t2 in FIG. 10, the controller 7 sets the target current value of the supply current of the solenoid 11a (C1) to the high value Ihi (i.e., the maximum value Imax of the DC control range), because only the clutch 6a (C1) needs to be operated, i.e., engaged, and sets the target current value of the supply current of the other clutches 6b to Ed (C2, B1, B2) to the low value Ilo (i.e., the minimum value Imin of the DC control range). In FIG. 10, the contents of the current control method for controlling the solenoids 11a to 11d are represented by hatching and no-hatching. The diagonal hatching around the target current values of the solenoids near the bottom of FIG. 10 represents a duration or amount of time where the current feed forward control is implemented, and the absence of the diagonal hatching around the target current values of the solenoids represents a duration or amount of time where a current feedback control is implemented.

In the period up until time t1, when the controller 7 predicts and determines the upper limit (Gmax) and the lower limit (Gmin) of the outputtable gear positions as 1st (gear) and 2nd (gear), the controller 7 performs the current feedback control of the supply current of the solenoid 11c (B1) corresponding to the clutch 6c (B1), which may possibly be operated when a gear shift operation is performed as a shift pattern from 1st gear to 2nd gear. Then, the controller 7 performs the current feed forward control of the supply current of the solenoids 11a, 11b, 11d (C1, C2, B2) corresponding to the other clutches 6a, 6b, 6d (C1, C2, B2). As a result, the processing load is reduced as compared with a situation where all the solenoids 11a to 11d are subjected to the current feedback control.

When the vehicle speed increases and the outputtable gear positions include not only 1st gear and 2nd gear, but also 3rd gear at time t1, even if the current gear position at time t1 is 1st gear, there is a possibility due to the vehicle speed for an upshift from 1st gear directly to 3rd gear. As such, the controller 7 sets the solenoid 11d (B2) of the clutch 6d (B2) that may possibly be engaged as a target solenoid. Consequently, the controller 7 switches the current control method of the solenoid 11d (B2) from the current feed forward control to the current feedback control at time t1. As a result, the processing load of the controller 7 and CPU 9 increases at time t1.

When the controller 7 provides instructions to shift to 2nd gear at time t2, the target current of the solenoid 11c (B1) is set to an intermediate value between the high value Ihi and the low value llo (as shown between times t2 and t3 in FIG. 10), and the current feedback control is performed on the solenoid 11c (B1). Then, the clutch 6c (B1) slip-engages while the turbine rotation number decreases slightly from the synchronized rotation number corresponding to the 1st gear position, and the turbine rotation number changes to the synchronized rotation number corresponding to the 2nd gear position. Subsequently, when the clutch 6c engages at time t3, the controller 7 sets the target current of the solenoid lie (B1) to the high value Ihi, and performs the current feedback control. This completes the upshifting operation for upshifting from the 1st gear position to the gear position to 2nd. That is, the upshift to the 2nd gear position is complete at time t3,

Thereafter, when the driver relaxes the depression of, or releases the accelerator pedal, the accelerator opening degree decreases. Consequently, the input turbine torque also decreases, and the condition changes from “driving” to “driven” through “in-between” at time t4. At time t4, the vehicle speed starts to decrease.

At and after time t4, there is an upshift possibility from 2nd gear to 3rd gear (i.e., 2nd→3rd). However, in such an initial stage of the gear shift operation, the controller 7 determines, as a target solenoid, the solenoid(s) to operate that correspond to shift-candidate gear positions involving the shifting to 3rd gear. That is, the controller 7 determines that the solenoid to engage for the shift to 3rd gear at the initial stage is the solenoid 11d (B2), and determines that the solenoid to release is the solenoid 11c (B1). During the upshift from 2nd gear to 3rd gear in the “driven” state, the control responsiveness of the solenoid 11d (B2) does not need to be improved at the initial stage of shifting, and the shift process is mainly controlled by the solenoid 11c (B1). Consequently, the controller 7 determines the solenoid 11d (B2) as a non-target solenoid, and performs the feed forward control on the solenoid 11d (B2). As a result, the processing load of the controller 7 and the CPU 9 is reduced during the period from time t4 to time t5.

Thereafter, when a shift instruction is input for shifting to the 3rd gear position at time t5, the controller 7 again performs the current feedback control by setting the solenoid 11d (B2) as a target solenoid. Subsequently, during a period between time t5 and time t6, the target current value of the solenoid 11c (B1) to operate (i.e., to release/disengage) is set to an intermediate value between the high value Ihi and the low value Ilo, and is then gradually lowered (e.g., in a stepwise manner) toward the low value Ilo while performing the current feedback control. The target current value of the solenoid 11d (B2) to operate (i.e., to engage) is set to the high value Ihi at time t6 for performing the current feedback control. At time t5, when the driver depresses the accelerator pedal after an input of the shift instruction to shift to the 3rd gear position, the accelerator opening degree increases.

Thus, during the period between time t5 and time t6, the control responsiveness is improved, even though the processing load increases at the same time. While the turbine rotation number decreases somewhat from the synchronized rotation number corresponding to the 2nd gear position, the clutch 6c (B1) operates to transition from the engagement state to the release state, and the clutch 6d (B2) operates to slip-engage from the release state. When the clutch 6c (B1) transitions to the release state and the clutch 6d (B2) transitions to the engagement state, the input turbine rotation number becomes the synchronized rotation number corresponding to the 3rd gear position.

Then, at time t6, even after the clutch 6c is fully released and the clutch Cd is fully engaged, the controller 7 keeps the target current value of the solenoid 11c (B1) at the low value Ho for performing the current feedback control, and keeps the target current value of the solenoid 11d (B2) at the high value Ihi for performing the current feedback control. In such manner, the gear position shifts completely to 3rd gear.

After time t6, when the accelerator opening degree and the throttle opening degree respectively increase as the driver continues to depress the accelerator pedal, and, as the vehicle speed increases, the input turbine torque increases from a low value range that is lower than a predetermined range (e.g., the “driven” range), passes through the “in-between” range, and increases to a high value range that is higher than a predetermined range (e.g., the “driving” range).

Meanwhile, when the outputtable gear position is maintained as is, e.g., the potential gears for shifting being 1st gear, 2nd gear, and 3rd gear, based on the vehicle speed and the accelerator opening degree, the controller 7 is put in a state in which the gear position may possibly be downshifted from 3rd gear to 2nd gear, or from 3rd gear to 1st gear. When downshifting the gear position from 3rd gear to 2nd gear, in case that the input turbine torque is within the predetermined range or in a range higher than that (e.g., in the “in-between” or “driving” range), the clutch 6d (B2) is used in the initial stage of the shift control. As a result, the control responsiveness of the clutch 6c (B1) does not need to be improved at time t7.

Therefore, the controller 7 changes the current control method of the solenoid 11c (B1) from the feedback control to the feed forward control. Although not shown in the drawing, when the shift instruction is received for the shifting the gear position, for example, from 3rd gear to 2nd gear, the controller 7 determines that the solenoid 11c (B1) is a target solenoid, and resumes the current feedback control of such solenoid 11c (B1).

Thereafter, when the vehicle speed increases thither, the outputtable gear positions change accordingly. For example, at time t8, the range of the outputtable gear positions expands to 1st gear, 2nd gear, 3rd gear, and 4th gear. At time t8, because the outputtable gear position now expands to include 4th gear, the controller 7 determines that the solenoid 11b (C2) is a target solenoid to operate, and switches the current control method of the solenoid 11b (C2) to the current feedback control method. Subsequently, at time t9, the range of outputtable gear positions is reduced to 2nd gear, 3rd gear, and 4th gear. At time t9, the controller 7 does not change the current control method for any of the solenoids 11a to 11d. In such manner, the current control of the solenoids can be performed by appropriately switching the current feed forward control method and the current feedback control method.

### Comparison Result of Processing Load

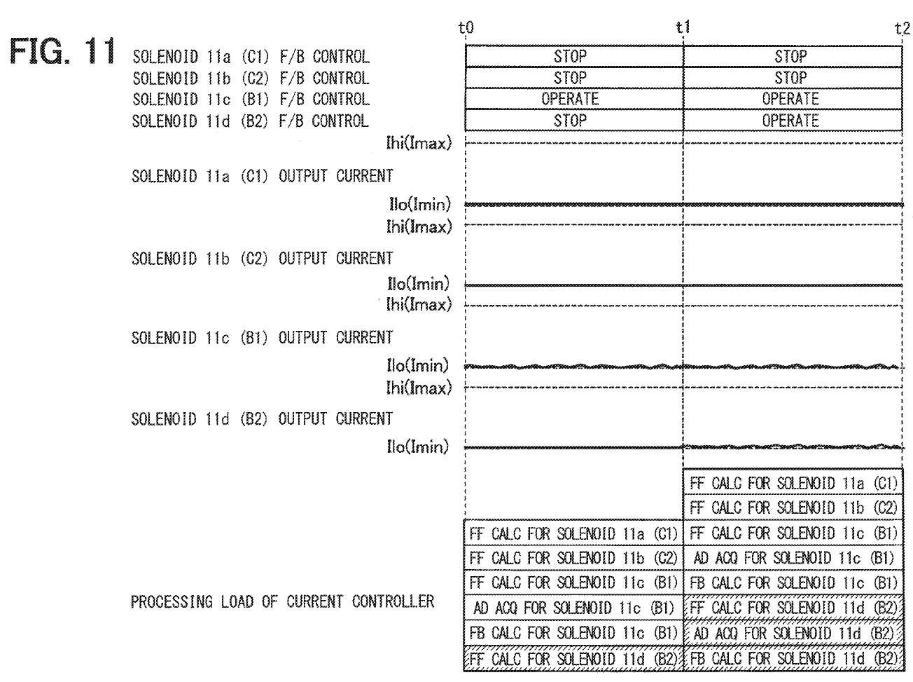

FIG. 11 illustrates the change of the operation state of the current feedback control and the change in the processing load amount at and around time t1 in FIG. 10. During a period between time t0 and t1, the controller 7 performs the control by the current feedback control method only for the solenoid 11c (B1), and performs, for the other solenoids 11a (C1), 11b (C2) and 11d (B2), the current feed forward control. However, after time t1, the solenoid 11d (B2) is also controlled by the current feedback control.

During the period between time to and time t1, the controller 7 feedback-controls the supply current of only the solenoid 11c (B1) as a target solenoid, thereby calculates the FF value for the feed forward control with respect to the target current value of the solenoid 11c (B1), detects and acquires the A/D conversion value of the supply current of the target solenoid 11c (B1), and calculates the FB value. However, since the controller 7 performs the current feed forward control for the current control of the other non-target solenoids 11a, 11b, 11d, the controller 7 needs to calculate the FF value only as shown by the hatching up to time t1 in FIG. 11. In such manner, the processing load of the controller 7 and the CPU 9 is reduced.

On the other hand, during the period between time t1 and time t2. since the controller 7 feedback-controls the supply current of the solenoids 11c (B1) and 11d (B2) respectively as a target solenoid, the controller 7 needs to calculate the FF value for both the solenoids 11c (B1) and 11d (B2), as well as detecting and acquiring the A/D conversion value of the supply current and calculating the FB value for the solenoids 11c (B1) and 11d (B2). Consequently, as shown in FIG. 11, the processing load increases as shown by the diagonal hatching after time t1 in FIG. 11.

### Summary and Effect of the Present Embodiment

As described above, according to the present embodiment, the controller 7 distinguishes a target solenoid to operate (e.g., 11c) from a non-target solenoid that does not operate (e.g., 11a, 11b, 11d) when there is a possibility of a gear change (e.g., based on the vehicle speed), or when the gear position is currently being changed/shifted (i.e., a gear change in progress), and changes the current control method for controlling the supply of electric current to the target and non-target solenoids. That is, a different current control method may be used for each solenoid (e.g., may vary from solenoid to solenoid). For example, the controller 7 may perform the current feedback control at U1 to U5 in FIG. 9 for the target solenoid 11c, but may perform the current feed forward control for the non-target solenoids 11a, 11b and 11d at U1, U2, U6, and U5 in FIG. 9. That is, the current control of the non-target solenoids 11a, 11b, 11d may be performed by applying a current control method that puts a lighter processing load on the controller 7 and the CPU 9.

Consequently, the control responsiveness at the time of performing the shift process can be changed to distinguish among the target solenoid 11c and the non-target solenoids 11a, 11b, 11d, and the control responsiveness of the target solenoid 11c can be raised/increased in advance, e.g before receiving the shift instruction. Further, after receiving the shift instruction, it is possible to raise the control responsiveness during the actual shifting. Since the controller 7 changes the current control method (i.e., applies different methods distinctively) to the target solenoid 11c and to the non-target solenoids 11a, 11b, 11d, as compared to cases where the current control is uniformly performed by using a single current control method with a heavy processing load, the processing load using the automatic transmission controller/vehicle control system 1 of the present disclosure is reduced. In addition, the controller 7 distinguishes the solenoid 11c as a target solenoid to operate when there is a possibility of changing/shifting a gear position to the post-change gear position, or when the gear position is currently changed to the post-change gear position. Therefore, even when a shift instruction to change/shift the gear position is actually input/received, the controller 7 can control the supply current of the target solenoid 11c by using the heavy-processing-load current control method, without deteriorating the level of control responsiveness.

The controller 7 switches (i.e., selects one of) the current control methods, in view of the weight of the processing load for an appropriate current control for supplying an electric current to each of the solenoids 11a to 11d. That is, based on the control situation and as ranked in the following order from the heaviest processing load to the lightest processing load, one of the dither-chopper control method, the current feedback control method without using the dither-chopper control, and the current feed forward control method can he used for the current control.

Since the controller 7 narrows down, or sifts, the shift-candidate, or “may-possibly-be-used,” gear positions to only one or a few positions (e.g., two) based on the operation state (of the driver) and the in-vehicle state (of the vehicle), the controller 7 does not have to consider the possibility of shifting to each of all gear positions (of the transmission mechanism 3b), and as such, the controller 7 is thereby limited from raising the control responsiveness for all of the solenoids, As a result, the target solenoid(s) to operate can be narrowed down to only one or a few, and the processing load to the controller 7 and the CPU 9 can be reduced. In particular, when the position of the shift lever is in the D range, the shift-candidate, post-change gear position(s) is/are sifted to only a few based on the current, pre-change gear position (e.g., 3rd), the D range shift line that is stored in and input from the memory 10, the current accelerator opening degree (i.e., the current throttle opening degree), and the current vehicle speed. As a result, the number of the target solenoids that need to have a highly responsive control (i.e., a high control responsiveness) decreases, and the processing load to the controller 7 and the CPU 9 can be reduced. In addition, when the position of the shift lever is in the M mode, the shift-candidate, post-change gear positions are sifted to only a few (e.g., to the solenoid 11c only) based on the current, pre-change gear position, the M-mode shift line that is stored in and input from the memory 10, and the current vehicle speed. Thus, the number of the target solenoids (e.g., only 11c) that need to have the highly responsive control decreases, thereby reducing the processing load to the controller 7 and the CPU 9.

The controller 7 distinguishes the solenoid to operate and the other solenoids from among the solenoids 11a to 11d based on the driving/driven state at the time of slip-engagement situation of the components from the engine system 2 to the transmission mechanism 3b. Consequently, the timber of the target solenoids can be decreased based on the state of the input torque of the transmission mechanism 3b.

### Other Embodiments

The present disclosure is not limited to the above-described embodiment and, may be modified or expanded in the following manner. The TCU 4, the range detector 5a, and the sensor signal detector 5b may be provided integrally, that is in one body, or may be provided in separate bodies. The solenoid drive controller 7 and the solenoid driver 8 that are described above as internal components of the TCU 4 may have one/integral body or may have separate bodies. A part of the above-described embodiment may be dispensed with and omitted. Various modifications of the present disclosure may be considered as encompassed in the present disclosure, as long as such modifications pertain to the gist of the present disclosure.

Although the present disclosure is described based on the embodiments herein, the present disclosure is not limited to such embodiments nor to the configuration/structure described therein. The present disclosure is intended to cover various modification examples and equivalents thereof. In addition, various modes/combinations, which have one or more elements added/subtracted thereto/therefrom, may also be considered as the present disclosure and understood as being within the technical scope thereof.

What is claimed is:

1. An automatic transmission controller comprising:
a current controller configured to perform a current control to supply an electric current to at least one of a plurality of solenoids, the plurality of solenoids provided to correspond respectively to a plurality of gear positions for shilling a current gear position of a transmission mechanism to another one of the plurality of gear positions;
a distinguisher configured to distinguish (i) a target solenoid to operate from (ii) a non-target solenoid when a pre-change gear position of the transmission mechanism for a shifting operation is being changed or is going to be changed to a post-change gear position, wherein
the current controller is further configured to perform the current control of the non-target solenoid with a current control method having a lighter processing load than a current control method for the current control of the target solenoid.

2. The automatic transmission controller of claim 1, wherein
the current controller is further configured to perform the current control for the target solenoid and the non-target solenoid from among a dither-chopper control method, a current feedback control method without using a dither-chopper control, and a current feed forward control method, and wherein the dither-chopper control method has a highest processing load, the current feedback control method without using a dither-chopper control has an intermediate processing load, and the current feed forward control method has a lightest processing load.

3. The automatic transmission controller of claim 1 further comprising:
an input section configured to input an operation state and an in-vehicle state, wherein
while the distinguisher distinguishes the target solenoid from the non-target solenoid, the distinguisher is further configured to sift post-change gear positions to one or more shift-candidate gear positions to which the pre-Change gear position is going to be changed based on the operation state and the in-vehicle state that are input to the input section.

4. The automatic transmission controller of claim 3 further comprising:
a range information acquirer for acquiring range information from a range detector that detects a current range of a shift lever; and
a D range shift line input section for inputting a D range shift line, wherein
when the range information acquirer has acquired a D range as the range information after detection by the range detector, the distinguisher is further configured to sift the shift-candidate gear positions based on a current pre-change gear position, an input of the D range shift line, a current accelerator opening degree or a current throttle opening degree, and a current vehicle speed.

5. The automatic transmission controller of claim 3 further comprising:
a range information acquirer for acquiring range information from a range detector that detects a current range of a shift lever and
an M mode shift line input section for inputting an M mode shift line, wherein
when the range information acquirer has acquired an M mode as the range information after detection by the range detector, the distinguisher is further configured to sift the shift-candidate gear positions based on a current pre-change gear position, an input of the M mode shift line, and a current vehicle speed.

6. The automatic transmission controller of claim 1, wherein
the distinguisher is further configured to distinguish the target solenoid to operate from the non-target solenoid based on a driving state and a driven state in a slip-engagement situation of components between an engine system and the transmission mechanism.
